(19) United States
(12) Patent Application Publication
(10) Pub. No.: US 2004/0183946 A1
(43) Pub. Date: Sep. 23, 2004

(54) Apparatus and method for obtaining an atomic clock signal broadcast

(76) Inventors: Yancy T. Chen, Campbell, CA (US); Michael C. Ip, Fremont, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/392,676

(22) Filed: Mar. 19, 2003

(51) Int. Cl. H04N 7/00; H04N 5/44

(52) U.S. Cl. 348/465; 348/725

(57) ABSTRACT

In one embodiment of the invention, an apparatus for obtaining an atomic clock signal broadcast, includes: a tuner configured to receive a broadcast transmission signal including an atomic clock signal; a decoder coupled to the tuner and configured to separate the atomic clock signal from the broadcast transmission signal; a logic circuit coupled to the decoder and configured to generate a control signal based upon a time value of the atomic clock signal; and an internal computer clock coupled to the logic circuit and configured to synchronize a clock time output with the time value of the atomic clock signal, in response to the control signal from the logic circuit.

### TECHNICAL FIELD

Embodiments of the present invention relate generally to an apparatus and method for obtaining an atomic clock signal broadcast.

### BACKGROUND

The United States government owns and operates an “Atomic Clock” that is located in Boulder, Colo. This Atomic Clock is accurate to a very small infinitesimal error margin of approximately 10 billionths of a second, and is recognized by the U.S. government as the official U.S. time. The time and date maintained by the Atomic clock is sent out via 60 kilohertz radio waves, and particular clocks and watches are designed to pick up that signal and to adjust their clock output to match the Atomic Clock.

The atomic clock signal covers a radius of approximately 1,864 miles from its broadcast origin of Boulder, Colo. The atomic clock signal is weaker on the U.S. east coast and west coast, and therefore, it may take longer for a clock to pick up the atomic clock signal at those locations. The atomic clock signal will penetrate almost all buildings, except typically commercial steel buildings that have few windows.

Personal computers lose the accuracy in their clock output for approximately one (1) minute to two (2) minutes after one year, if their internal computer clocks are not synchronized with the atomic clock. Thus, it is typically difficult to obtain the precise accurate time reading from a clock in a personal computer. Conventional personal computers are required to be connected to the Internet in order to obtain an atomic clock signal that can update a clock of the personal computer (PC). Current operating system software permits access to the atomic clock broadcast to update the PC clock as long as there is an Internet connection for broadcasting the atomic clock signal to the computer. For example, the XP product from Microsoft Corporation, Redmond, Wash., can synchronize a clock in a personal computer with the atomic clock by use of the Internet. Thus, conventional PCs are disadvantageously limited by their requirement of an Internet connection in order to update their clocks. Computer users who do not have access to an Internet Service Provider (ISP) are unable to synchronize the clock in their computers with the atomic clock. In addition, a particular computer may not be configured for connection and operation with the Internet.

Thus, the current approaches and/or technologies are limited to particular capabilities and/or suffer from various constraints.

### SUMMARY OF EMBODIMENTS OF THE INVENTION

In one embodiment of the invention, an apparatus for obtaining an atomic clock signal broadcast, includes: a tuner configured to receive a broadcast transmission signal including an atomic clock signal; a decoder coupled to the tuner and configured to separate the atomic clock signal from the broadcast transmission signal; a logic circuit coupled to the decoder and configured to generate a control signal based upon a time value of the atomic clock signal; and an internal computer clock coupled to the logic circuit and configured to synchronize a clock time output with the time value of the atomic clock signal, in response to the control signal from the logic circuit.

In another embodiment, a method for obtaining an atomic clock signal broadcast, includes: receiving a broadcast transmission signal with an atomic clock signal; separating the atomic clock signal from the broadcast transmission signal; generating a control signal in response to a time value of the atomic clock signal; and synchronizing a clock time output of an internal computer clock with the time value of the atomic clock signal.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a computer, in accordance with an embodiment of the invention.

FIG. 2 is a flowchart of a method in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

An embodiment of the invention advantageously permits a clock in a computer (e.g., a personal computer or notebook computer) to be automatically maintained to the most accurate time reading, by use of a television/FM/AM tuner card. Thus, the user is not required to manually adjust the internal clock in the computer in order to maintain the accuracy of the clock time output.

An embodiment of the invention advantageously permits a clock in a computer to be automatically maintained for accuracy, without the requirement of an Internet connection. Thus, an embodiment of the invention does not require the computer to be connected to the Internet in order to access an atomic clock signal and to update the clock in the computer. In contrast, current operating system software permits a clock in the computer to be updated as long as the computer can be connected to the Internet, so that the computer can receive the atomic clock broadcast from the Internet to update the computer clock. An embodiment of the invention advantageously avoids this requirement of current technology.

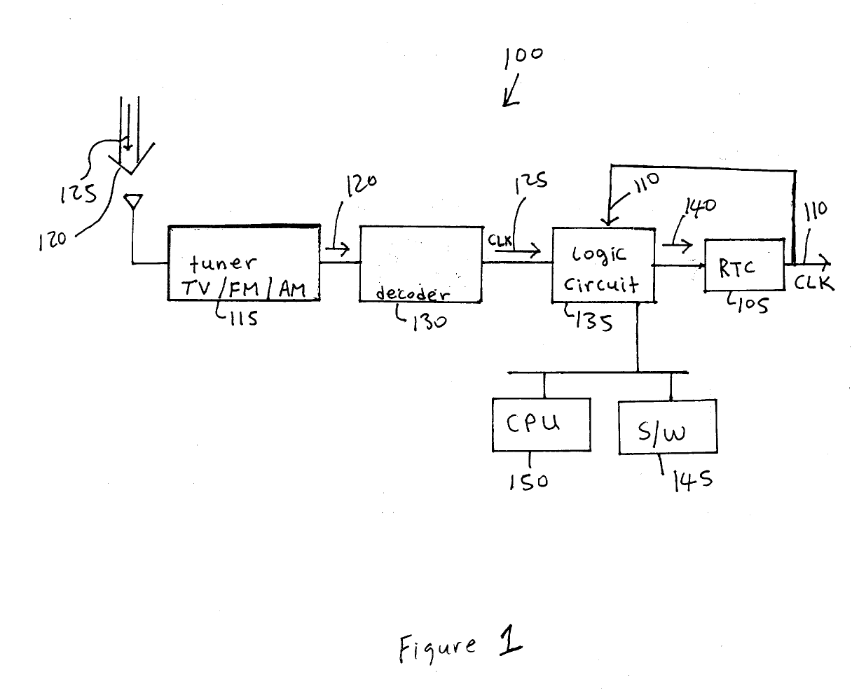

FIG. 1 is a block diagram illustrating a computer 100, in accordance with an embodiment of the invention. The computer 100 includes a clock (RTC) 105 that serves as the internal clock for the computer 105. The clock signal form the clock (RTC) 105 can be used to provide a clock time output 110. The computer 105 may be any implemented as any suitable computing device such as, for example, a personal computer (PC), notebook, laptop computer, workstation, server, hand-held computer, and/or another type of computing device. For purposes of describing the functionalities of embodiments of the invention, various known components and modules/software of a computer are not shown in FIG. 1.

It is noted that personal computers (PCs) use binary conversion in order to calculate time. In binary conversion, the rounding of the time value is performed and this operation leads to the clock (RTC) in a PC to lose accuracy in the clock time output over a period of time. An internal clock (RTC) 105 in a personal computer is not originally designed to serve as a time-keeper for the computer user. Instead, the clock (RTC) 105 was originally intended for internal operations for the computer 100, such as clocking functions that are utilized by the processor (e.g. central processing unit 150) of the computer 100. As a result, a clock (RTC) 105 for the computer 100 is not designed to have the highest accuracy in order to save costs for the computer 100.

In contrast, a conventional time-keeper clock does not use binary conversion in order to generate a clock time output. However, conventional time-keeper clocks are not able to keep time precisely, and as a result, all clocks also need to be synchronized periodically in order to generate an accurate clock time output. For example, a time-keeper clock can lose accuracy up to about 30 seconds per day, depending on the crystal used for the clock. Furthermore, age can affect the crystal. For example, the crystal can run faster or slower after a certain age, and this condition may lead to inaccuracy in the clock time output of the time-keeper clock. Additionally, heat can have an affect on crystal operation, and this condition may lead to inaccuracy in the clock time output of the time-keeper clock

The computer 100 includes a tuner 115 that can receive a broadcast signal 120 with the atomic clock signal 125. The tuner 115 can be, for example, a television tuner, AM/FM tuner, AM tuner, FM tuner, or a tuner with at least some of the functionalities of these different types tuners. Thus, the tuner 115 can receive a video signal, audio signal, or a combination of audio/video signal from a wireless broadcast transmission.

A decoder 130 receives the broadcast signal 120 from the tuner 115 and decodes the atomic clock signal 125 from the broadcast signal 120. The decoder 130 extracts (or separates) the atomic clock signal 125 from the broadcast signal 120 by use of a decoding technique, in order to output the clock signal 125. The decoding technique used by the decoder 130 to extract the atomic clock signal 125 can be a standard demodulation technique or other suitable decoding techniques. The computer 100 then tunes (updates) the clock (RTC) 105 to synchronize with the atomic clock signal 125, as described below.

A logic circuit 135 can program the clock (RTC) 105 to synchronize with the atomic clock signal 125, so that the clock (RTC) 105 generates an updated and accurate clock time output 110 after being synchronized by the logic circuit 135. The logic circuit 135 typically includes circuitry that generates an output control signal 140 with a value that is dependent on the value of the clock signal 125. The control signal 140 is then used by the clock (RTC) 105 to increase or decrease the value of the clock time output 110. For example, the logic circuit 135 includes a standard circuit that compares the time values of the atomic clock signal 125 and clock time output 110, and a standard circuit that generates a control signal 140 with a value that is dependent on the difference between the time values of the atomic clock signal 125 and clock time output 110. The control signal 140 is then transmitted to the internal clock (RTC) 105 permit the internal clock (RTC) to increase or decrease the time value of the clock time output 110, depending on the value of the control signal 140.

The operation of the logic circuit 135 is described in the following example. Assume that the clock time output 110 of the internal clock (RTC) 105 is approximately 11:05AM. Assume further that the clock time value provided by the atomic clock signal 125 is 11:00AM. In response to atomic clock signal 125 with the 11:00AM time value, the logic circuit 135 will generate a control signal 140 to permit the clock (RTC) 105 to synchronize the clock time output 110 to match the 11:00AM time value of the atomic clock signal 125. As another example, assume that assume that the clock time output 110 of the internal clock (RTC) 105 is approximately 10:55AM. Assume further that the clock time value provided by the atomic clock signal 125 is 11:00AM. In response to atomic clock signal 125 with the 11:00AM time value, the logic circuit 135 will generate a control signal 140 to permit the clock (RTC) 105 to synchronize the clock time output 110 to match the 11:00AM time value of the atomic clock signal 125.

As long as the computer 100 is on, the computer 100 can receive an atomic clock signal 125 as wireless broadcast signal. The atomic clock signal 125 will synchronize the clock (RTC) 105 of the computer 100 with the atomic clock signal 125.

In an embodiment, the clock (RTC) 105 is synchronized or updated by the logic circuit 135 at a given interval (e.g., every 24 hours) and/or during a power-up of the computer 100. An optional software program 145 that is executed by the central processing unit (CPU) 150 and that runs in the background of the computer operation can trigger the clock (RTC) synchronization activity based upon the computer user's preference. The optional software program 145 can be any suitable conventional software that triggers an event based upon settings that are programmed by the computer user, so that the logic circuit 155 generates the control signal 140 at a given interval to permit synchronization of the clock time output 110 from the clock (RTC) 105.

Since the computer 100 obtains that atomic clock signal 125 from a wireless broadcast signal 120, the computer 100 advantageously does not require a connection to the Internet in order to synchronize the computer clock (RTC) 105 with the atomic clock signal 125. As a result, a user of the computer 100 who is, for example, traveling or does not have access to an ISP, can have a computer device with a clock (RTC) that is synchronized with the atomic clock 125 even if an Internet connection for the computer is not available.

An embodiment of the invention also advantageously maintains and does not require reconfiguration of a current internal clock (RTC) 105 in personal computers (PCs). The above mentioned methods and apparatus can synchronize the clock (RTC) 105 for time-keeping accuracy. As a result, a computer 100 can provide accurate time-keeping function, without increasing the price/cost of the computer 100 since the use of an expensive clock for the computer 100 is advantageously avoided.

Additionally, if the computer 100 is configured to support entertainment functions, such as recording a television program or triggering another event where time is important, then it is important that the clock (RTC) 105 is accurate and is periodically synchronized with the atomic clock 125, so that the computer 100 can record the television at the proper time. An embodiment of the invention advantageously provides an apparatus and method to synchronize the clock (RTC) 105 that is useful to support entertainment functions. Additionally, if the computer 100 is configured to support other functions, such as alarm clock functionality, then it is important that the clock (RTC) 105 is accurate and is periodically synchronized.

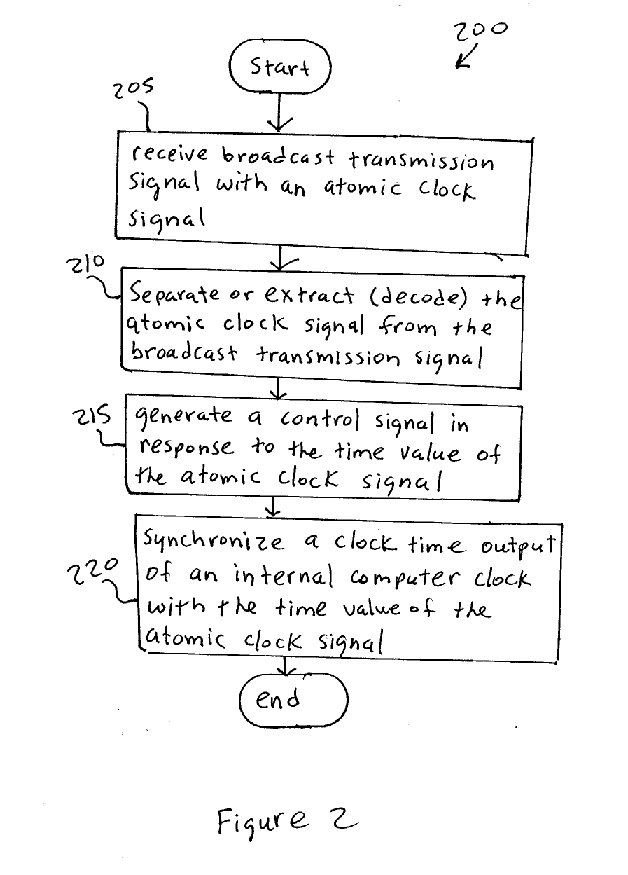

FIG. 2 is a flowchart of a method 200 in accordance with an embodiment of the invention. The method 200 begins by having a tuner receive (205) a broadcast transmission signal with an atomic clock signal. The broadcast transmission signal may include a video signal, audio signal, or a combination of audio/video signal. A decoder then separates or extracts (210) the atomic clock signal from the broadcast transmission signal. A logic circuit 135 will generate (215) a control signal in response to the time value of the atomic clock signal. An internal clock (RTC) of the computer will synchronize (220) a clock time output in response to the control signal, so that the clock time output of the internal clock (RTC) is synchronized with the time value of the atomic clock signal. Since the computer 100 obtains that atomic clock signal from a wireless broadcast transmission signal, the computer 100 advantageously does not require a connection to the Internet in order to synchronize the clock time output of the internal clock (RTC) 105 with the time value of the atomic clock signal 125.

The various engines or modules discussed herein may be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

While the present invention has been described herein with reference to particular embodiments thereof, a latitude of modification, various changes and substitutions are intended in the foregoing disclosures, and it will be appreciated that in some instances some features of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular embodiment disclosed as the best mode contemplated for carrying out this invention, but that the invention will include all embodiments and equivalents falling within the scope of the appended claims.

What is claimed is:

1. An apparatus for obtaining an atomic clock signal broadcast, the apparatus comprising:
a tuner configured to receive a broadcast transmission signal including an atomic clock signal;
a decoder coupled to the tuner and configured to separate the atomic clock signal from the broadcast transmission signal;
a logic circuit coupled to the decoder and configured to generate a control signal based upon a time value of the atomic clock signal; and
an internal computer clock coupled to the logic circuit and configured to synchronize a clock time output with the time value of the atomic clock signal, in response to the control signal from the logic circuit.

2. The apparatus of claim 1, wherein the apparatus is implemented in a computer.

3. The apparatus of claim 2, wherein the computer is configured to support entertainment functions.

4. The apparatus of claim 2, wherein the computer does not require a connection to the Internet in order to synchronize the clock time output with the time value of the atomic clock signal.

5. The apparatus of claim 1, wherein the broadcast transmission signal includes at least one of a video signal and an audio signal.

6. The apparatus of claim 1, wherein the internal computer clock is configured to support internal operations of a computer.

7. A method for obtaining an atomic clock signal broadcast, the method comprising:
receiving a broadcast transmission signal with an atomic clock signal;
separating the atomic clock signal from the broadcast transmission signal;
generating a control signal in response to a time value of the atomic clock signal; and
synchronizing a clock time output of an internal computer clock with the time value of the atomic clock signal.

8. The method of claim 7, wherein the method is implemented in a computer.

9. The method of claim 8, wherein the computer is configured to support entertainment functions.

10. The method of claim 8, wherein the computer does not require a connection to the Internet in order to synchronize the clock time output with the time value of the atomic clock signal.

11. The method of claim 7, wherein the broadcast transmission signal includes at least one of a video signal and an audio signal.

12. The method of claim 7, wherein the internal computer clock is configured to support internal operations of a computer.

13. An apparatus for obtaining an atomic clock signal broadcast, the apparatus comprising:
means for receiving a broadcast transmission signal with an atomic clock signal;
means for separating the atomic clock signal from the broadcast transmission signal;
means for generating a control signal in response to a time value of the atomic clock signal; and
means for synchronizing a clock time output of an internal computer clock with the time value of the atomic clock signal.

14. The apparatus of claim 13, wherein the apparatus is implemented in a computer.

15. The apparatus of claim 14, wherein the computer is configured to support entertainment functions.

16. The apparatus of claim 14, wherein the computer does not require a connection to the Internet in order to synchronize the clock time output with the time value of the atomic clock signal.

17. The apparatus of claim 13, wherein the broadcast transmission signal includes at least one of a video signal and an audio signal.

18. The apparatus of claim 13, wherein the internal computer clock is configured to support internal operations of a computer.
